(19) United States
(12) Patent Application Publication
(10) Pub. No.: US 2019/0061433 A1
(43) Pub. Date: Feb. 28, 2019

(54) TREAD FOR A PNEUMATIC TIRE

(71) Applicant: The Goodyear Tire & Rubber Company, Akron, OH (US)

(72) Inventor: Julien Alexandre VAISSAUD, Arlon (BE)

(21) Appl. No.: 15/683,801

(22) Filed: Aug. 23, 2017

(51) Int. Cl. B60C 11/12

(52) U.S. Cl. CPC B60C 11/1236; B60C 2011/0353

(57) ABSTRACT

A tread for a tire includes a first circumferential groove extending in a circumferential direction of the pneumatic tire, a second circumferential groove extending in the circumferential direction of the pneumatic tire, a third circumferential groove extending in the circumferential direction of the pneumatic tire, and a fourth circumferential groove extending in the circumferential direction of the pneumatic tire. The first, second, third, and fourth circumferential grooves defining first, second, third, fourth, and fifth ribs. The first and fifth ribs include lateral grooves and incisions extending circumferentially fully around the first and fifth ribs. The incisions of the first and fifth ribs reduce noise generated by the tread under operating conditions.

### FIELD OF INVENTION

The present invention relates to a pneumatic tire with an improved tread, and more particularly, relates to a pneumatic tire tread having improved acoustic characteristics.

### BACKGROUND OF THE INVENTION

Conventionally, in addition to circumferential main grooves and lateral grooves, pneumatic tire treads may have sipes on a tread surface in order to demonstrate favorable functional characteristics (e.g., low rolling resistance, good traction, good durability, etc.).

### Definitions

The following definitions are controlling for the disclosed invention.

“Axial” and “Axially” means the lines or directions that are parallel to the axis of rotation of the tire.

“Axially Inward” means in an axial direction toward the equatorial plane.

“Axially Outward” means in an axial direction away from the equatorial plane.

“Bead” or “Bead Core” generally means that part of the tire comprising an annular tensile member of radially inner beads that are associated with holding the tire to the rim.

“Belt Structures” or “Reinforcement Belts” or “Belt Package” means at least two annular layers or plies of parallel cords, woven or unwoven, underlying the tread, unanchored to the bead, and having both left and right cord angles in the range from 18 degrees to 30 degrees relative to the equatorial plane of the tire.

“Carcass” means the tire structure apart from the belt structure, tread, undertread over the plies, but including the beads.

“Circumferential” means circular lines or directions extending along the perimeter of the surface of the annular tread perpendicular to the axial direction; it can also refer to the direction of the sets of adjacent circular curves whose radii define the axial curvature of the tread, as viewed in cross section.

“dBA” means A-weighted decibels, abbreviated dBA, or dBa, or dB(a), which are an expression of the relative loudness of sounds in air as perceived by the human ear. In the A-weighted system, the decibel of sounds at low frequencies are reduced, compared with unweighted decibels, in which no correction is made for audio frequency. This correction is made because the human ear is less sensitive at low audio frequencies, especially below 1000 hertz, than at high audio frequencies.

“Directional Tread Pattern” means a tread pattern designed for specific direction of rotation.

“Equatorial Plane” means the plane perpendicular to the tire's axis of rotation and passing through the center of its tread; or the plane containing the circumferential centerline of the tread.

“Footprint” means the contact patch or area of contact of the tire tread with a flat surface under normal load pressure and speed conditions.

“Groove” means an elongated void area in a tread that may extend circumferentially or laterally in the tread in a straight, curved or zigzag manner. It is understood that all groove widths are measured perpendicular to the centerline of the groove.

“Hertz” means number of cycles per second.

“Lateral” means a direction going from one sidewall of the tire towards the other sidewall of the tire.

“Net to gross” means the ratio of the net ground contacting tread surface to the gross area of the tread including the ground contacting tread surface and void spaces comprising grooves, notches and sipes.

“Notch” means a void area of limited length that may be used to modify the variation of net to gross void area at the edges of blocks.

“Ply” means a cord-reinforced layer of rubber coated radially deployed or otherwise parallel cords.

“Radial” and “radially” mean directions radially toward or away from the axis of rotation of the tire.

“Radial Ply Tire” means a belted or circumferentially-restricted pneumatic tire in which at least one ply has cords which extend from bead to bead are laid at cord angles between 65 degrees and 90 degrees with respect to the equatorial plane of the tire.

“Shoulder” means the upper portion of sidewall just below the tread edge.

“Sidewall” means that portion of a tire between the tread and the bead.

“Sipe” means a groove having a width in the range of 0.2 percent to 0.8 percent of the tread width. Sipes are typically formed by steel blades having a 0.4 to 1.6 mm, inserted into a cast or machined mold.

“Tangential” and “Tangentially” refer to segments of circular curves that intersect at a point through which can be drawn a single line that is mutually tangential to both circular segments.

“Tread” means the ground contacting portion of a tire.

“Tread width” (TW) means the greatest axial distance across the tread, when measured (using a footprint of a tire,) laterally from shoulder to shoulder edge, when mounted on the design rim and subjected to a specified load and when inflated to a specified inflation pressure for said load.

“Void Space” means areas of the tread surface comprising grooves, notches and sipes.

### SUMMARY OF THE INVENTION

A tread for a tire in accordance with the present invention includes a first circumferential groove extending in a circumferential direction of the pneumatic tire, a second circumferential groove extending in the circumferential direction of the pneumatic tire, a third circumferential groove extending in the circumferential direction of the pneumatic tire, and a fourth circumferential groove extending in the circumferential direction of the pneumatic tire. The first, second, third, and fourth circumferential grooves defining first, second, third, fourth, and fifth ribs. The first and fifth ribs include lateral grooves and incisions extending circumferentially fully around the first and fifth ribs. The incisions of the first and fifth ribs reduce noise generated by the tread under operating conditions.

According to another aspect of the tread, the first rib has between 6 and 12 incisions.

According to still another aspect of the tread, the fifth rib has between 6 and 12 incisions.

According to yet another aspect of the tread, the incisions of the first rib have a depth between 1.0 mm and 4.0 mm.

According to still another aspect of the tread, the incisions of the fifth rib have a depth between 1.0 mm and 4.0 mm.

According to yet another aspect of the tread, the incisions of the first rib have a lateral spacing between 1.0 mm and 6.0 mm.

According to still another aspect of the tread, the incisions of the fifth rib have a lateral spacing between 1.0 mm and 6.0 mm.

According to yet another aspect of the tread, the incisions of the first rib have a width between 0.5 mm to 1.5 mm.

According to still another aspect of the tread, the incisions of the fifth rib have a width between 0.5 mm to 1.5 mm.

According to yet another aspect of the tread, the incisions of the first and fifth ribs have depths of 2.0 mm.

A pneumatic tire in accordance with the present invention has a tread. The tread includes a first circumferential groove extending in a circumferential direction of the pneumatic tire, a second circumferential groove extending in the circumferential direction of the pneumatic tire, a third circumferential groove extending in the circumferential direction of the pneumatic tire, and a fourth circumferential groove extending in the circumferential direction of the pneumatic tire. The first, second, third, and fourth circumferential grooves defining first, second, third, fourth, and fifth circumferential ribs. Each of the first, second, third, fourth, and fifth ribs includes incisions extending circumferentially fully around the tread. The incisions reduce noise generated by the tread under operating conditions.

According to another aspect of the pneumatic tire, each rib has between 6 and 12 incisions.

According to still another aspect of the pneumatic tire, the incisions of each rib have a depth between 1.0 mm and 4.0 mm.

According to yet another aspect of the pneumatic tire, the incisions of each rib have a lateral spacing between 1.0 mm and 6.0 mm.

According to still another aspect of the pneumatic tire, the incisions of each rib have a width between 0.5 mm to 1.5 mm.

A method in accordance with the present invention reduces noise created by a tread of a pneumatic tire under operating conditions. The method includes the steps of: extending a first incision across the tread in a circumferential direction; and extending a second incision across the tread in the circumferential direction, the second incision being parallel to the first incision and an axial distance from the first incision between 1.0 mm and 6.0 mm, edge to edge.

According to another aspect of the method, the first and second incisions each have a radial depth between 1.0 mm and 4.0 mm.

According to still another aspect of the method, the first and second incisions each have an axial width between 0.5 mm and 1.5 mm.

According to yet another aspect of the method, the first and second incisions each have a radial depth of about 2.0 mm.

According to still another aspect of the method, another step extends third, fourth, fifth, and sixth incisions across the tread in the circumferential direction. The third, fourth, fifth, and sixth incisions are parallel to the first and second incisions and an axial distance from an adjacent incision between 1.0 mm and 6.0 mm, circumferential edge to circumferential edge.

### BRIEF DESCRIPTION OF THE DRAWINGS

The present invention will be more clearly understood by the following description of some examples thereof, with reference to the accompanying drawings, in which:

FIG. 1 is a schematic orthogonal front view of a pneumatic tire having a tread in accordance with the present invention.

FIG. 2 is a schematic orthogonal detail view of the pneumatic tire and tread of FIG. 1.

FIG. 3 is a schematic sectional view of the pneumatic tire and tread pattern along line 3-3 in FIG. 2.

FIG. 4 is a graph of ambient tire noise versus excitation frequency for three different treads.

### DESCRIPTION OF EXAMPLES OF THE PRESENT INVENTION

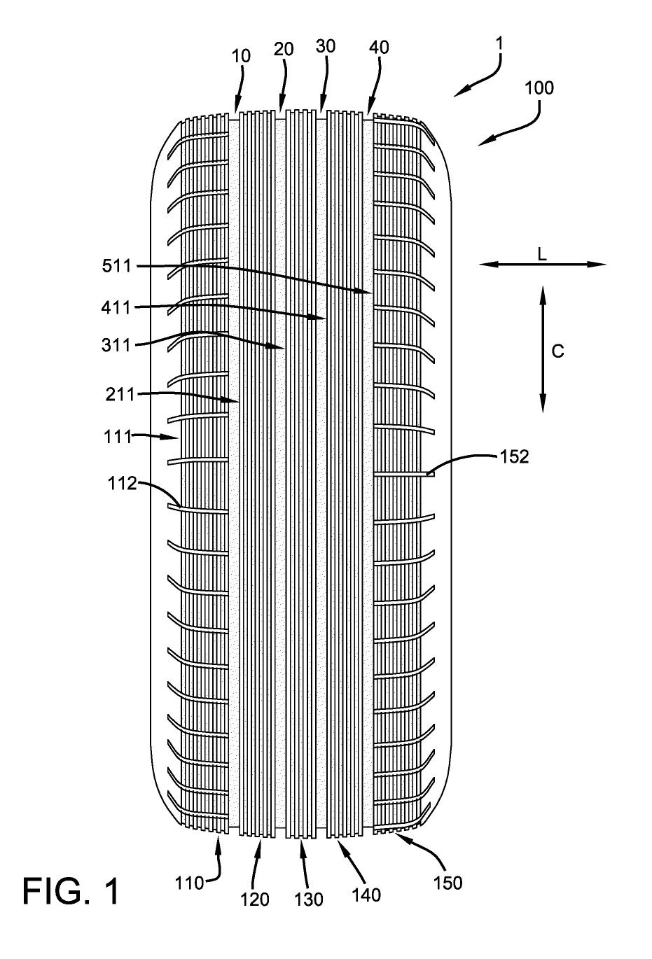

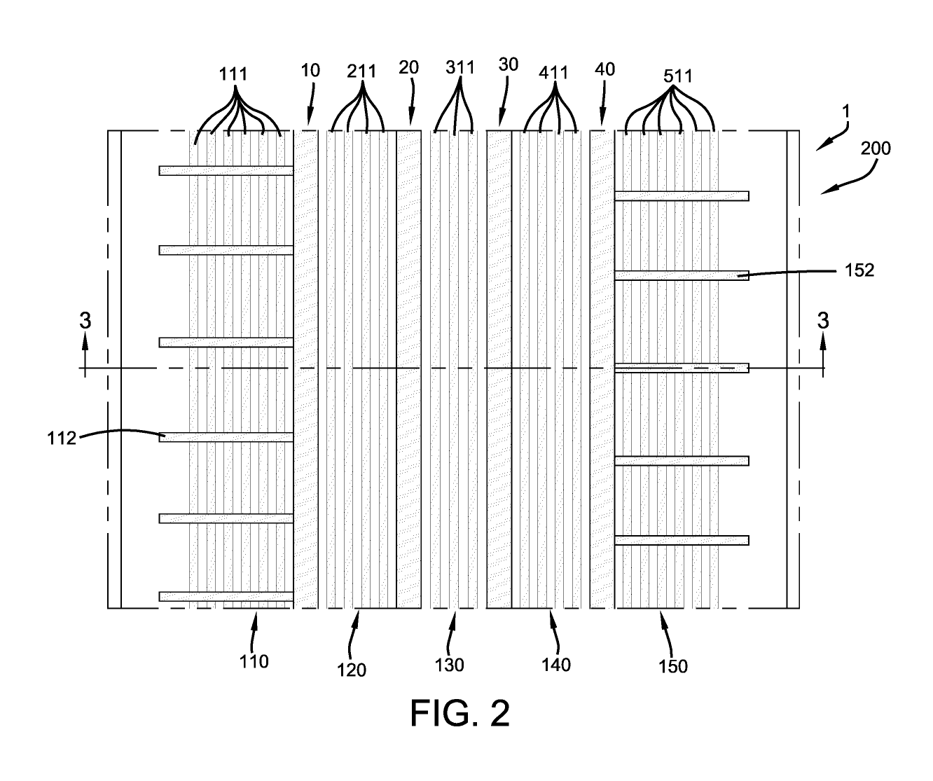

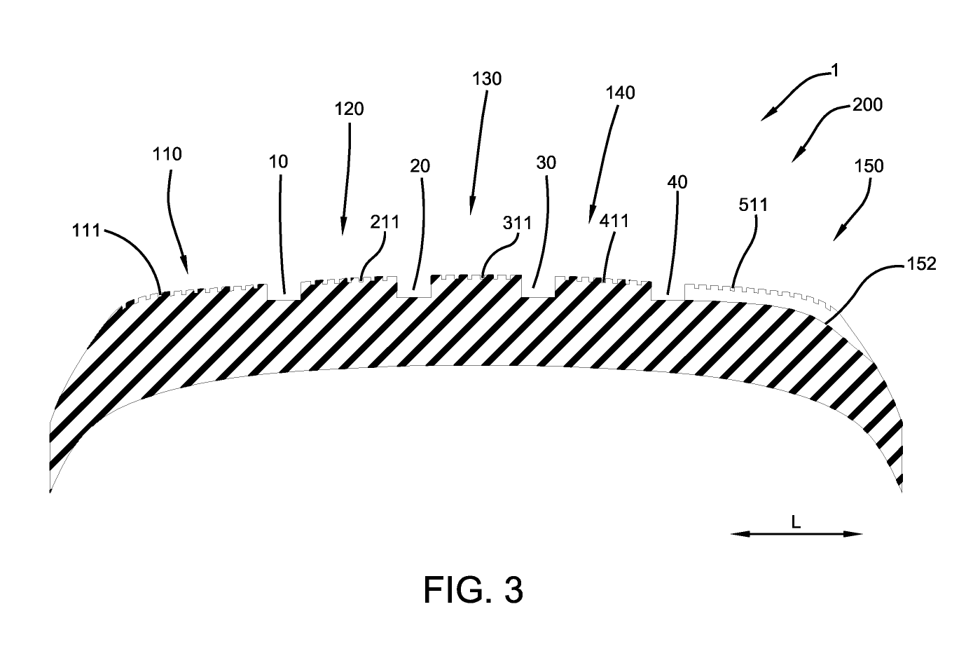

As shown in FIGS. 1-3, a pneumatic tire 1 in accordance with the present invention may include a tread 100 with a first main circumferential groove 10, a second main circumferential groove 20, a third main circumferential groove 30, and a fourth main circumferential groove 40 all extending in a circumferential direction C of the pneumatic tire forming the tread 100. Five land portions, or ribs 110, 120, 130, 140, 150 may be formed by these main circumferential grooves 10, 20, 30, 40. Each of the first and fifth ribs 110, 150 may have additional lateral grooves 112, 152 extending laterally L across the ribs 110, 150 forming discreet and circumferentially repeating blocks, or tread elements. The main circumferential grooves 10, 20, 30, 40 may have, for example, a lateral width between 3.0 mm and 20.0 mm and an example radial depth between 5.0 mm and 13.0 mm.

In accordance with the present invention, the first shoulder rib 110 may further have a plurality of circumferential incisions 111, or “zebra stripes”, extending fully around the circumference of the first rib. These incisions 111 may continue circumferentially through each of the lateral grooves 112. The number of incisions 111 may range from 2 to 12. The incisions 111 may have depths ranging from 1.0 mm to 4.0 mm, or about 2.0 mm. The incisions 111 may have widths ranging from 0.5 mm to 1.5 mm. The incisions 111 may have a lateral spacing, incision edge to incision edge, ranging from 1.0 mm to 5.0 mm. Said another way, the incisions 111 may be separated by ribs between 1.0 mm and 4.0 mm. The depth, width, and lateral spacing of the incisions 111 may all effect the amount of ambient noise mitigation produced by the incisions. Generally, mm may be an optimal depth and a greater density of incisions 111 decreases noise more than a lesser density of incisions.

In accordance with the present invention, the second intermediate rib 120 may further have a plurality of circumferential incisions 211, or “zebra stripes”, extending fully around the circumference of the second rib. The number of incisions 211 may range from 2 to 12. The incisions 211 may have depths ranging from 1.0 mm to 4.0 mm, or about 2.0 mm. The incisions 211 may have widths ranging from 0.5 mm to 1.5 mm. The incisions 211 may have a lateral spacing, incision edge to incision edge, ranging from 1.0 mm to 6.0 mm. Said another way, the incisions 211 may be separated by ribs between 1.0 mm and 5.0 mm. The depth, width, and lateral spacing of the incisions 211 may all effect the amount of ambient noise mitigation produced by the incisions. Generally, 2.0 mm may be an optimal depth and a greater density of incisions 211 decreases noise more than a lesser density of incisions.

In accordance with the present invention, the third center rib 130 may further have a plurality of circumferential incisions 311, or “zebra stripes”, extending fully around the circumference of the third rib. The number of incisions 311 may range from 2 to 12. The incisions 311 may have depths ranging from 1.0 mm to 4.0 mm, or about 2.0 mm. The incisions 311 may have widths ranging from 0.5 mm to 1.5 mm. The incisions 311 may have a lateral spacing, incision edge to incision edge, ranging from 1.0 mm to 6.0 mm. Said another way, the incisions 311 may be separated by ribs between 1.0 mm and 5.0 mm. The depth, width, and lateral spacing of the incisions 311 may all effect the amount of ambient noise mitigation produced by the incisions. Generally, 2.0 mm may be an optimal depth and a greater density of incisions 311 decreases noise more than a lesser density of incisions.

In accordance with the present invention, the fourth intermediate rib 140 may further have a plurality of circumferential incisions 411, or “zebra stripes”, extending fully around the circumference of the fourth rib. The number of incisions 411 may range from 2 to 12. The incisions 411 may have depths ranging from 1.0 mm to 4.0 mm, or about 2.0 mm. The incisions 411 may have widths ranging from 0.5 mm to 1.5 mm. The incisions 411 may have a lateral spacing, incision edge to incision edge, ranging from 1.0 mm to 6.0 mm. Said another way, the incisions 411 may be separated by ribs between 1.0 mm and 5.0 mm. The depth, width, and lateral spacing of the incisions 411 may all effect the amount of ambient noise mitigation produced by the incisions. Generally, 2.0 mm may be an optimal depth and a greater density of incisions 411 decreases noise more than a lesser density of incisions.

In accordance with the present invention, the fifth shoulder rib 150 may further have a plurality of circumferential incisions 511, or “zebra stripes”, extending fully around the circumference of the fifth rib. These incisions 511 may continue circumferentially through each of the lateral grooves 152. The number of incisions 511 may range from 2 to 12. The incisions 511 may have depths ranging from 1.0 mm to 4.0 mm, or about 2.0 mm. The incisions 511 may have widths ranging from 0.5 mm to 1.5 mm. The incisions 511 may have a lateral spacing, incision edge to incision edge, ranging from 1.0 mm to 6.0 mm. Said another way, the incisions 511 may be separated by ribs between 1.0 mm and 5.0 mm. The depth, width, and lateral spacing of the incisions 511 may all effect the amount of ambient noise mitigation produced by the incisions. Generally, 2.0 mm may be an optimal depth and a greater density of incisions 511 decreases noise more than a lesser density of incisions.

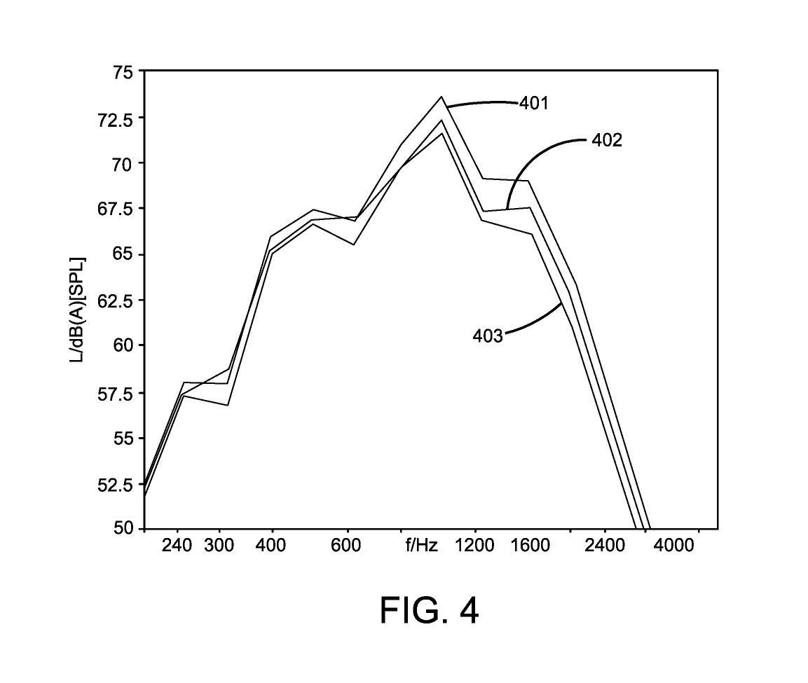

As can be seen in FIG. 4, a tread pattern 401 with no incisions produces more noise than the same tread pattern 402 having incisions 111, 511 only in the shoulder ribs 110, 150, as described above. Further, the tread pattern 402 with incisions 111, 511 only in the shoulder ribs 11, 150 produces more noise than the same tread pattern 403 having incisions 111, 211, 311, 411, 511 in all five ribs 110, 120, 130, 140, 150, as described above. These incisions 111, 211, 311, 411, 511 in each rib 110, 120, 130, 140, 150 (FIGS. 1-3) may reduce noise by as much as 1.4 dBA to 2.4 dBA at a tire speed of 50 kph. The incisions 111, 211, 311, 411, 511 have been shown to have little or no effect on rolling resistance of the tire 1 (e.g., +/−2 percent, etc.).

While the present invention has been described in connection with what is considered the most practical example, it is to be understood that the present invention is not to be limited to the disclosed arrangements, but is intended to cover various arrangements which are included within the spirit and scope of the broadest possible interpretation of the appended claims so as to encompass all possible modifications and equivalent arrangements.

What is claimed:

1. A tread for a tire comprising:
a first circumferential groove extending in a circumferential direction of the pneumatic tire;
a second circumferential groove extending in the circumferential direction of the pneumatic tire;
a third circumferential groove extending in the circumferential direction of the pneumatic tire; and
a fourth circumferential groove extending in the circumferential direction of the pneumatic tire, the first, second, third, and fourth circumferential grooves defining first, second, third, fourth, and fifth ribs, the first and fifth ribs including lateral grooves; and
incisions extending circumferentially fully around the first and fifth ribs, the incisions of the first and fifth ribs reducing noise generated by the tread under operating conditions.

2. The tread as set forth in claim 1 wherein the first rib has between 6 and 12 incisions.

3. The tread as set forth in claim 1 wherein the fifth rib has between 6 and 12 incisions.

4. The tread as set forth in claim 1 wherein the incisions of the first rib have a depth between 1.0 mm and 4.0 mm.

5. The tread as set forth in claim 1 wherein the incisions of the fifth rib have a depth between 1.0 mm and 4.0 mm.

6. The tread as set forth in claim 1 wherein the incisions of the first rib have a lateral spacing between 1.0 mm and 6.0 mm.

7. The tread as set forth in claim 1 wherein the incisions of the fifth rib have a lateral spacing between 1.0 mm and 6.0 mm.

8. The tread as set forth in claim 1 wherein the incisions of the first rib have a width between 0.5 mm to 1.5 mm.

9. The tread as set forth in claim 1 wherein the incisions of the fifth rib have a width between 0.5 mm to 1.5 mm.

10. The tread as set forth in claim 1 wherein the incisions of the first and fifth ribs have depths of 2.0 mm.

11. A pneumatic tire with a tread comprising:
a first circumferential groove extending in a circumferential direction of the pneumatic tire;
a second circumferential groove extending in the circumferential direction of the pneumatic tire;
a third circumferential groove extending in the circumferential direction of the pneumatic tire; and
a fourth circumferential groove extending in the circumferential direction of the pneumatic tire, the first, second, third, and fourth circumferential grooves defining first, second, third, fourth, and fifth ribs, each of the first, second, third, fourth, and fifth ribs including incisions extending circumferentially fully around the tread, the incisions reducing noise generated by the tread under operating conditions.

12. The pneumatic tire as set forth in claim 11 wherein each rib has between 6 and 12 incisions.

13. The pneumatic tire as set forth in claim 11 wherein the incisions of each rib have a depth between 1.0 mm and 4.0 mm.

14. The pneumatic tire as set forth in claim 1 wherein the incisions of each rib have a lateral spacing between 1.0 mm and 6.0 mm.

15. The pneumatic tire as set forth in claim 1 wherein the incisions of each rib have a width between 0.5 mm to 1.5 mm.

16. A method for reducing noise created by a tread of a pneumatic tire under operating conditions, the method comprising the steps of:
extending a first incision across the tread in a circumferential direction; and
extending a second incision across the tread in the circumferential direction, the second incision being parallel to the first incision and an axial distance from the first incision between 1.0 mm and 5.0 mm, edge to edge.

17. The method as set forth in claim 16 wherein the first and second incisions each have a radial depth between 1.0 mm and 4.0 mm.

18. The method as set forth in claim 17 wherein the first and second incisions each have an axial width between 0.5 mm and 1.5 mm.

19. The method as set forth in claim 18 wherein the first and second incisions each have a radial depth of about 2.0 mm.

20. The method as set forth in claim 19 further including the step of extending third, fourth, fifth, and sixth incisions across the tread in the circumferential direction, the third, fourth, fifth, and sixth incisions being parallel to the first and second incisions and an axial distance from an adjacent incision between 1.0 mm and 5.0 mm, circumferential edge to circumferential edge.
